(19) United States
(12) Patent Application Publication
(10) Pub. No.: US 2006/0080121 A1
(43) Pub. Date: Apr. 13, 2006

(54) Third-party confirmation of self-populated data

(76) Inventor: Lawrence H. Chiang, Palo Alto, CA (US)

Correspondence Address: MIN, HSIEH & HACK LLP, 8270 GREENSBORO DRIVE, SUITE 630, MCLEAN, VA, 22102, US

(21) Appl. No.: 11/211,409

(22) Filed: Aug. 25, 2005

Related U.S. Application Data
(60) Provisional application No. 60/604,746, filed on Aug. 25, 2004.

(51) Int. Cl. G06Q 99/00

(52) U.S. Cl. 705/1

(57) ABSTRACT

An online information system, such as a dating service, that provides third-party verification of self-populated data is provided. A user may initially provide their own data that identifies themselves as well as their desired match, for example, for a date. The system may then collect data from third-party sources, such as a credit reporting agency, to confirm the data provided by the user. The data provided by the user may then be scored based on the third-party data. For example, a report may be underwritten about the user based on their self-populated data and the third-party data. In addition, the system may allow for users to provide and respond to feedback about them.

### CROSS REFERENCE TO RELATED APPLICATION

This application claims the benefit of U.S. Provisional Patent Application No. 60/604,746, entitled “Third Party Confirmation of Self Populated Data,” filed on Aug. 25, 2004, the disclosure of which is expressly incorporated herein by reference in its entirety.

### FIELD OF THE INVENTION

This invention relates generally to online information systems and methods and, more particularly, to online information systems and methods for confirming self-populated data.

### BACKGROUND OF THE INVENTION

Online information systems, such as dating services, bulletin boards, personal ads, and classified ads, have become a popular application of the Internet. For example, online dating services have grown significantly in recent years.

Unfortunately, online information services are prone to incorrect data. This is because a significant portion of the data in these systems is provided by the users themselves. In online dating services, users are often tempted to misrepresent themselves, or conceal important information in order to make themselves appear more attractive. However, users of a dating service may also wish to keep certain information private, such as their home address and phone number.

It may therefore be desirable to provide online information systems and methods that provide its users with a mechanism to ensure the accuracy of its data while protecting the privacy of the users.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 shows an exemplary system that is consistent with embodiments of the present invention;

FIG. 2 shows an exemplary voice gateway that is consistent with embodiments of the present invention;

FIG. 3 shows an exemplary data structure that is consistent with embodiments of the present invention;

FIG. 4 shows an exemplary process flow that is consistent with embodiments of the present invention;

FIG. 5 shows an exemplary server configured in a manner that is consistent with embodiments of the present invention; and

FIGS. 6-15 show exemplary screen shots for a user interface that is consistent with embodiments of the present invention.

### DESCRIPTION OF THE EMBODIMENTS

Features of the invention will now be set forth in part in the description which follows, and in part will be obvious from the description, or may be learned by practice of the invention. It is to be understood that both the foregoing general description and the following detailed description are exemplary and explanatory only and are not restrictive of the invention.

Reference will now be made in detail to embodiments of the invention, an example of which is illustrated in the accompanying drawings. Wherever possible, the same reference numbers will be used throughout the drawings to refer to the same or like parts.

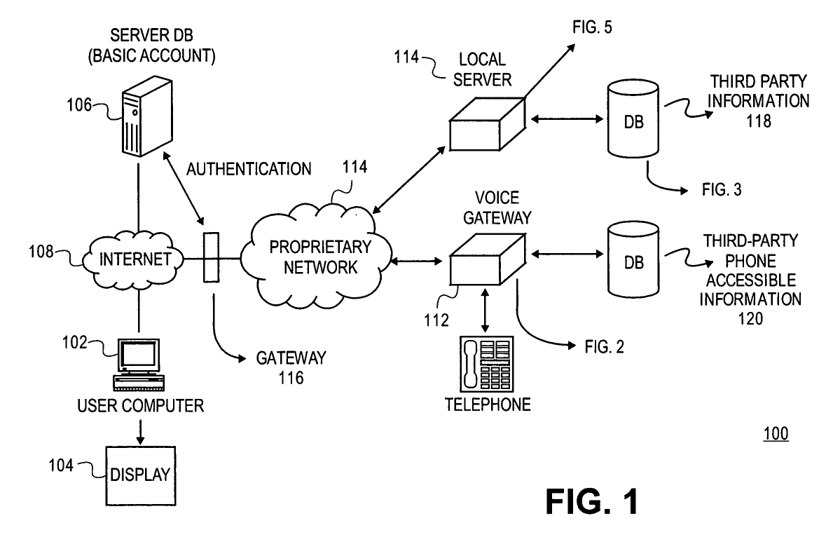

Referring now to FIG. 1, an exemplary system 100 that is consistent with embodiments of the present invention is shown. In general, the system 100 may be configured as an online dating service that uses an Internet-based web-site, where users or members access information about other members. In addition, the system 100 may also be configured to allow non-members of the service to access information about other members, for example, based on a fee or set of codes.

In particular, the system 100 may include a user computer 102 having a display 104. The user computer 102 may connect to a database server 106 via the Internet 108, or some other network. The database server 106 stores account information about the various users of the system 100, some of which information is self-populated or provided by the users. These components may be implemented using well known hardware and software.

The database server 106 may also be connected to a local server 110 and a voice gateway 112. As shown, the database server 106 may be coupled to the local server 110 and voice gateway 112 over a proprietary or private network 114. In addition, a gateway 116, such as a firewall, may also be implemented in order to secure the transactions between these devices. The proprietary network 114 may be implemented in a variety of ways, such as a local area network, wide area network, or through a virtual private network.

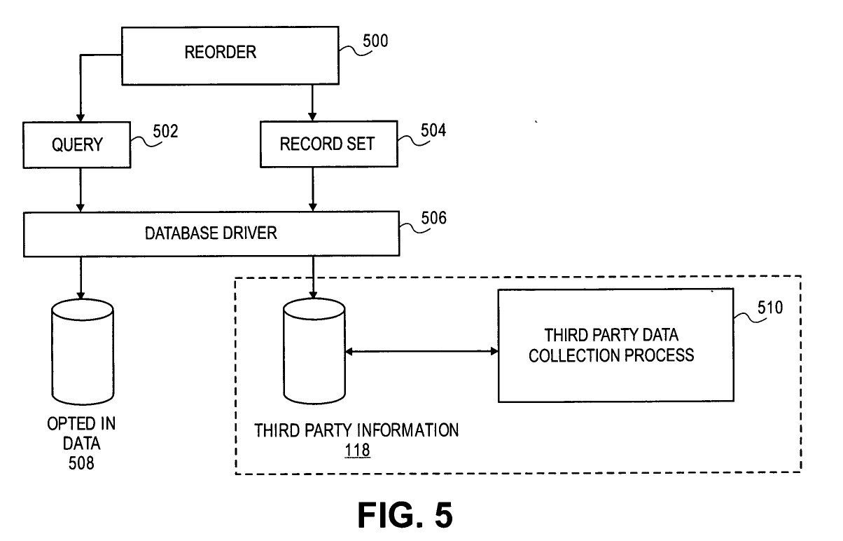

The local server 110 is configured to interface with third-party information 118 about users of the system that is confirmed. For example, in some embodiments, this third-party information 118 may be credit data from one or more credit reporting agencies. Other types of confirmed information, such as court filings, background checks, etc. may also be included as third-party information 118. The local server 110 may be configured and implemented using well known hardware and software. The local server is also further described with reference to FIG. 5.

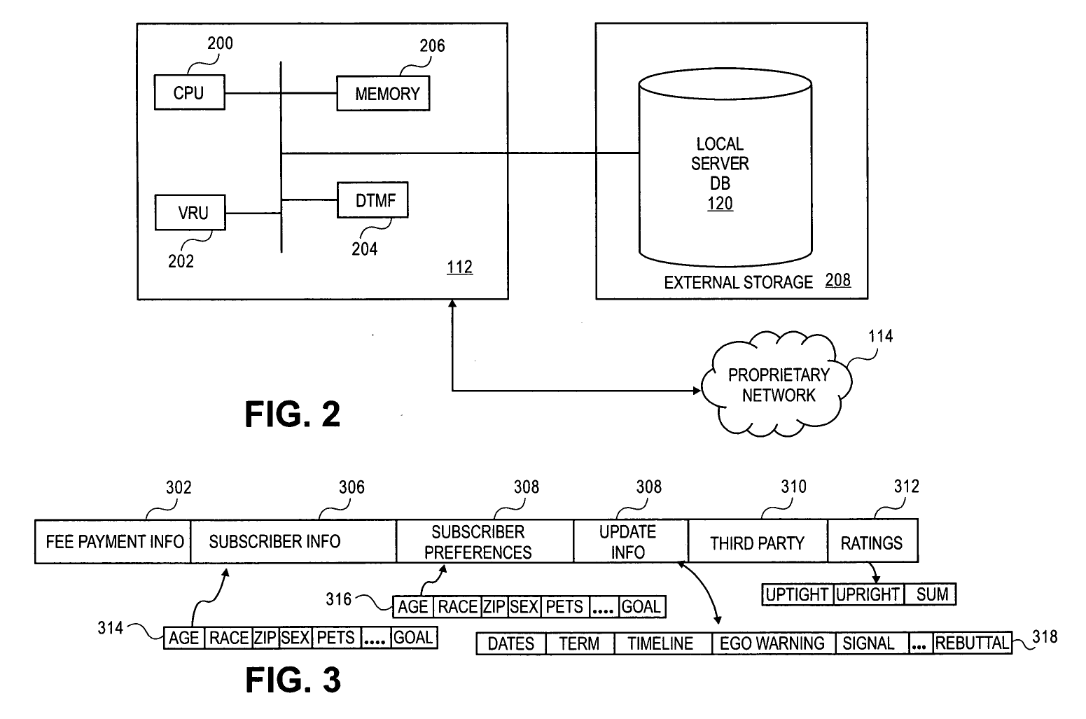

The voice gateway 112 provides access to the system via the telephone network and may be optionally provided in some embodiments of the present invention. The voice gateway 112 may interface with phone accessible information 120 from third-parties, such as credit information. The voice gateway is also further described with reference to FIG. 2.

FIG. 2 shows an exemplary voice gateway that is consistent with embodiments of the present invention. As shown, the voice gateway 112 may include a processor (“CPU”) 200, a voice response unit (“VRU”) 202, a voice network interface module (“DTMF”) 204, and a local memory 206. In addition to the voice network, the voice gateway 112 may be coupled to the proprietary network 114 and an external storage device 208 that stores the phone accessible third-party information 120. As shown in FIG. 2, the external storage device 208 may store a version of the local server database 120 and format its data in such a manner that it is accessible over the telephone network, e.g., the information may be provided in a voice format.

The CPU 200, VRU 202, DTMF 204, and local memory 206 may be implemented using well known hardware and software. Together these components are configured to allow users to access the third-party information 120 stored in the external storage device 208. For example, the voice gateway 112 may use well known protocols to receive voice requests via the DTMF module 204 or requests via the proprietary network 114. In response to these requests, the voice gateway 112 may query the database 120 in the external storage device 208 using well known query languages, such as structured query language (“SQL”).

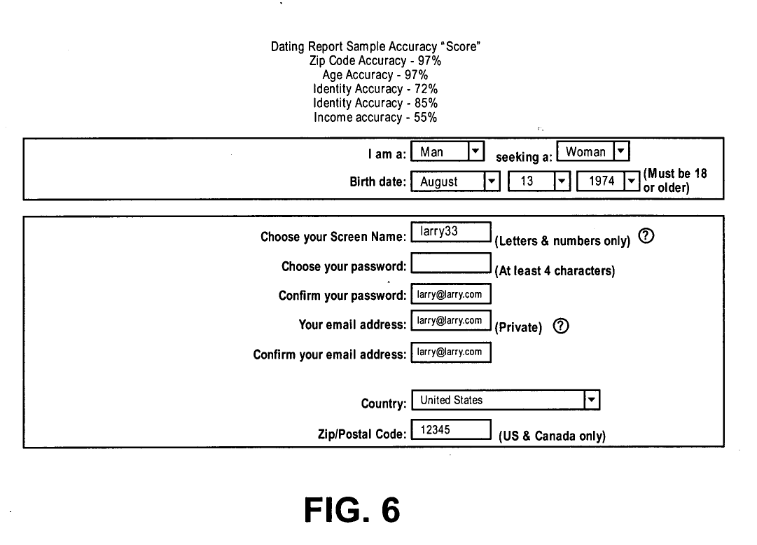

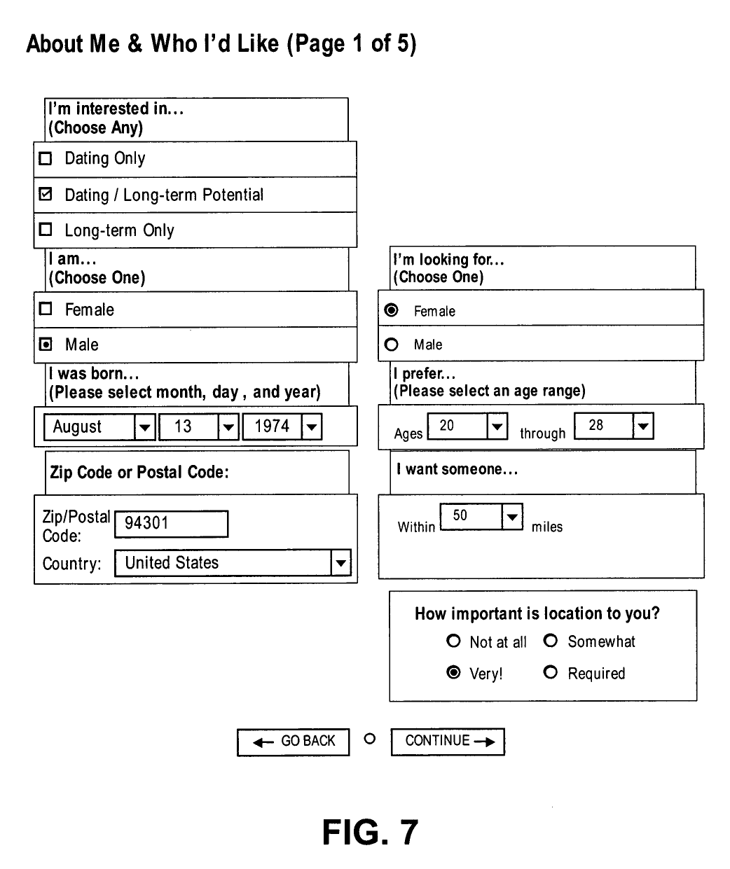

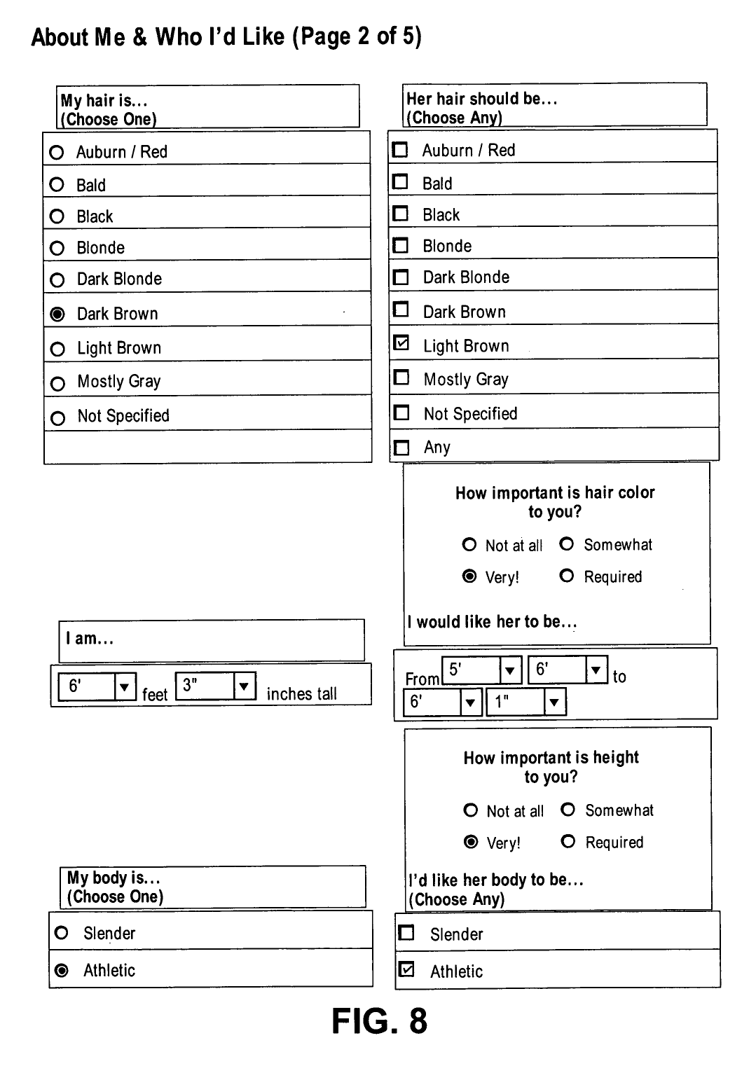

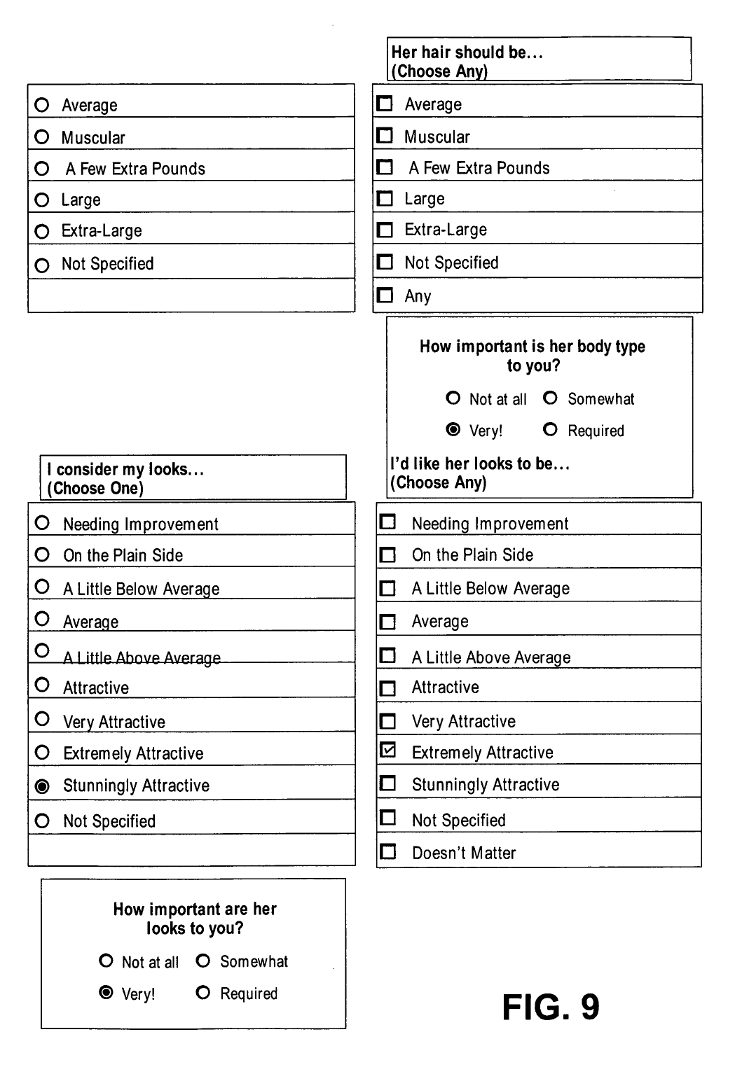

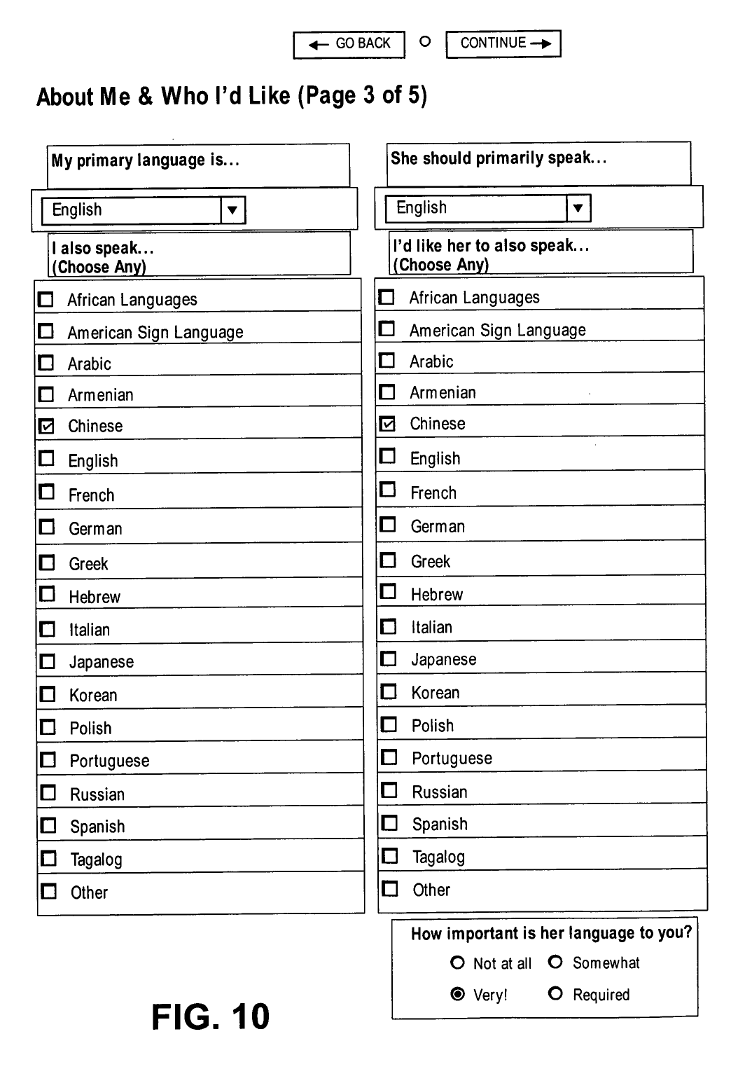

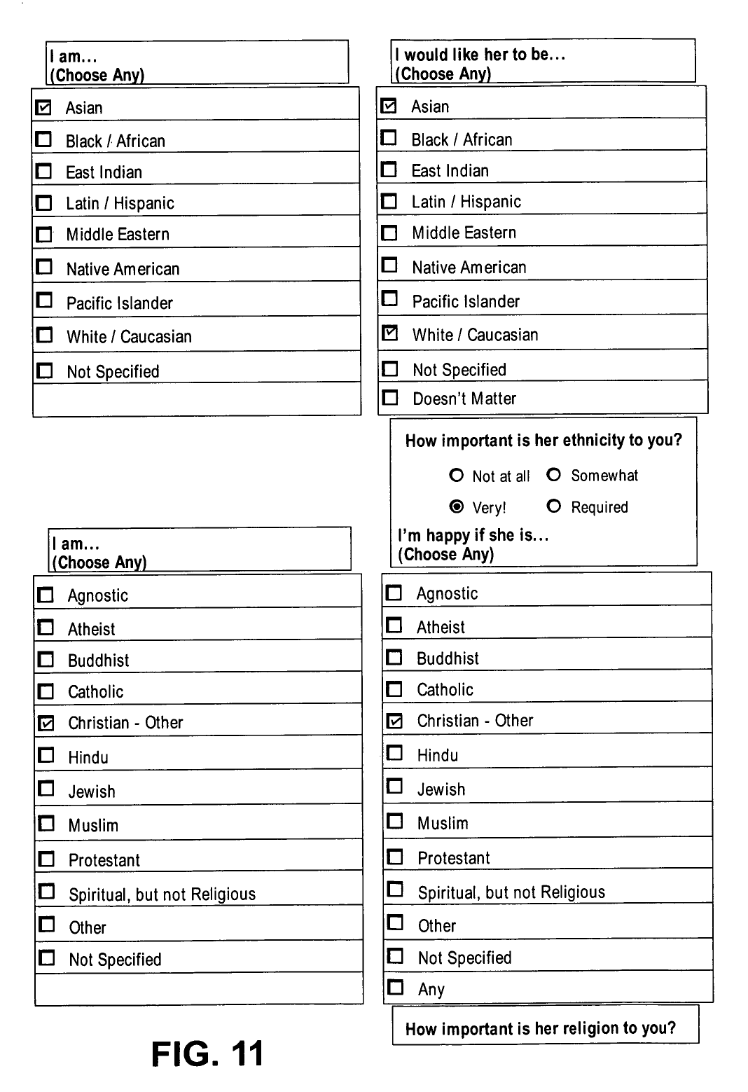

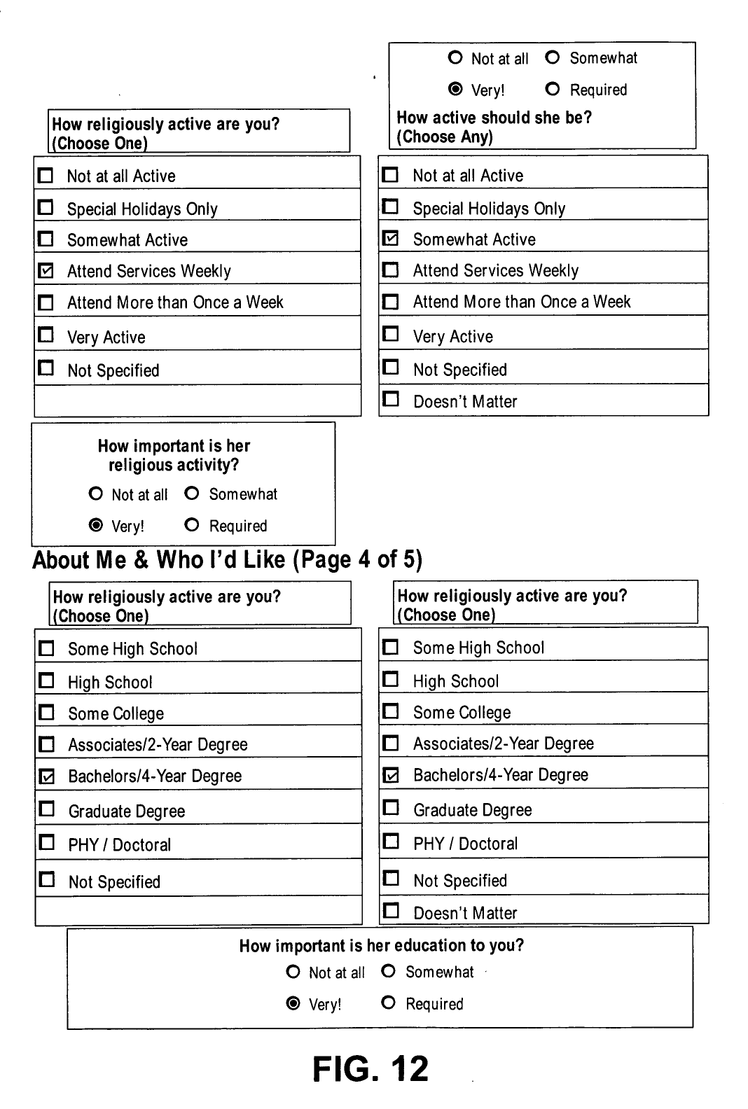

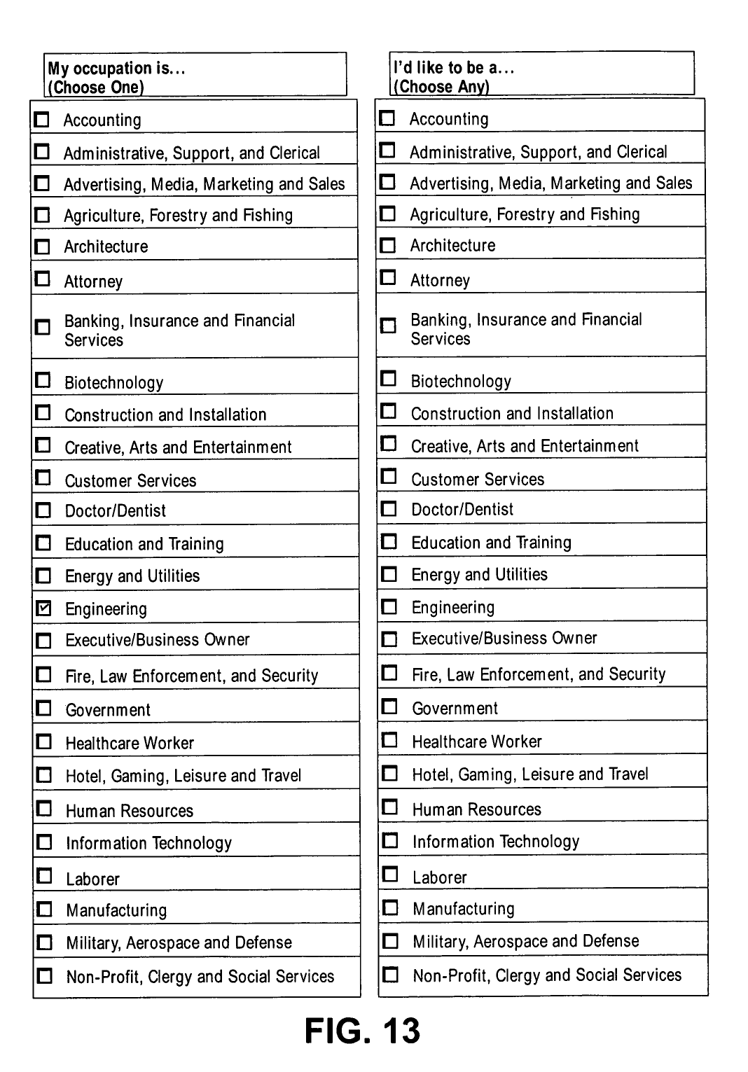

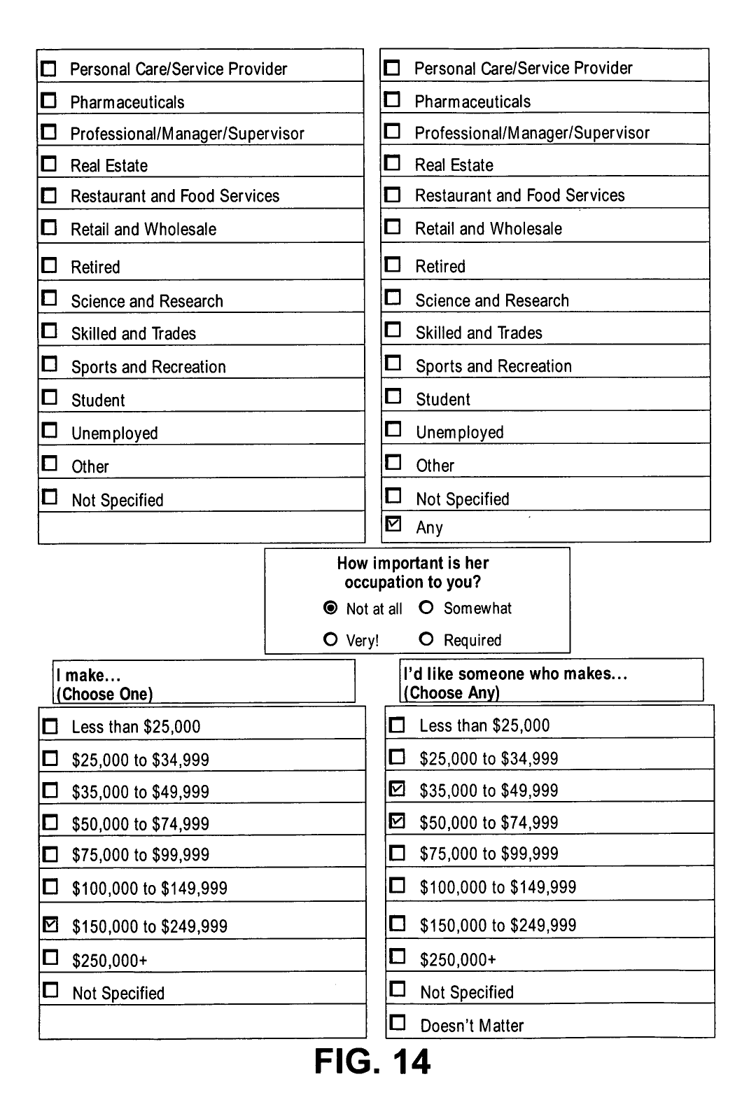

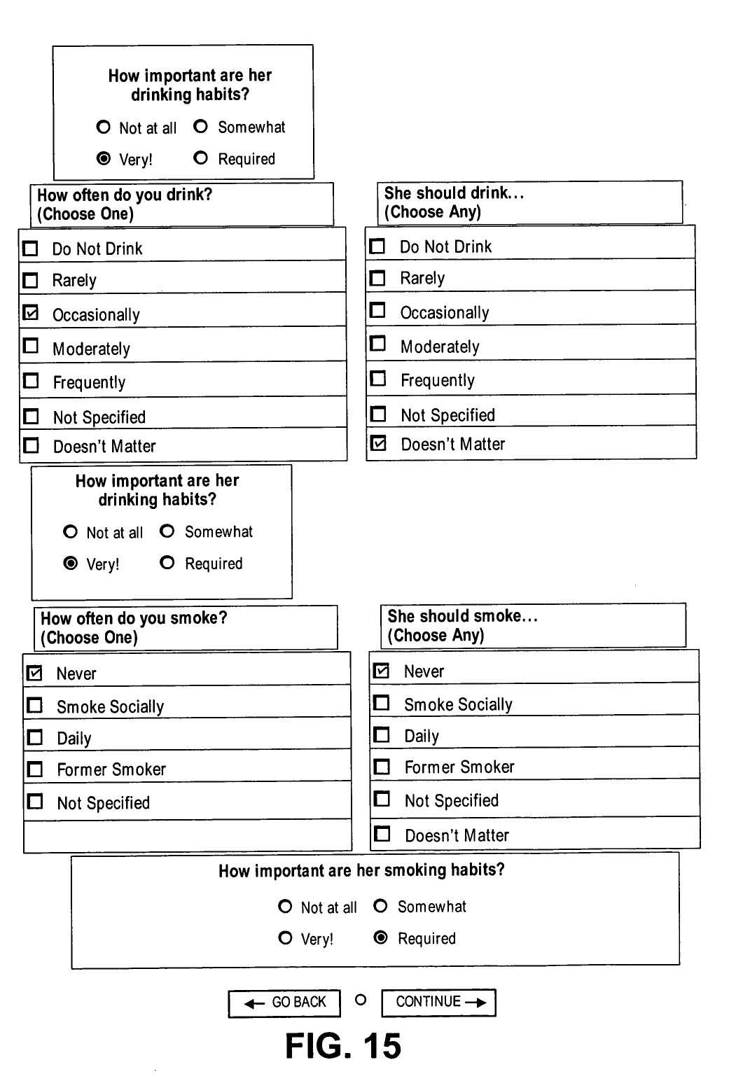

FIG. 3 shows an exemplary data structure that is consistent with embodiments of the present invention. The data managed by the local server 118 may be primarily self-populated by the users and members. This information may be entered manually or electronically, via a website. For example, a user may access a website and fill out various forms. Initially, the user may provide/enter personal information, such as a name, an address, date of birth, telephone number, photograph, etc. Examples of such online forms are shown with reference to FIGS. 6-15

As shown in FIG. 3, the local server 110 may store user account information 118 and requests in a variety of formats. In particular, the data structure 300 may include fields for fee payment information 302, subscriber identification information 304, subscriber preferences 306, update preferences 308, third-party account information 310, such as credit card numbers and social security numbers, and a rating of the user 312.

The subscriber information 302 may further include information 314, such as age, race, height, weight, zip code, address, gender, pets, career information, pictures, audio, video, etc. In other words, this information may include any data that is specifically associated with a user.

A user's membership or privileges may also be set forth in tiers, such as basic, enhanced, and deluxe memberships. For example, the higher membership levels may be based upon more detailed disclosure by the user and a higher level of third-party verification. This may, in essence, make the user's credentials and information more “trusted.”

A basic membership may only require confirmation of identity, height and weight, photograph, and marital status. The enhanced membership may go further to include verification of the user's income and a credit report. Finally, the deluxe membership could further include verification of driving history, criminal record check, and verification of professional licenses. Of course, one skilled in the art will recognize that a user's membership level may be differentiated in a variety of ways.

The subscriber preference information 306 may include information 316 that indicates the personal or dating preferences of the user. This information may include items such as age, race, zip code, pets, income, height, desires, etc.

The update information 308 includes information 318 that indicates how a user interacts with the system and a history of transactions. For example, the update information may include the dates that the user has participated, the length or term of their membership in the system, a timeline of their dates, any warnings posted about the user such as, for example, “ego” warnings, other signaling information such as, for example, location restrictions or age restrictions, and rebuttals by the user to comments posted about them. In addition, a user may be required to update their personal information on a periodic basis, such as, twice a year.

The third-party information 310 field includes information that has been confirmed about the user. For example, this information may include credit information, background checks, etc. Each user may provide various pieces of identification information, such as a social security number, to allow for the retrieval of this information. Other information can include a driver's license, photographs, a pay stub, a birth certificate or proof of citizenship, income tax form, credit report, resumes, or an e-mail address. Based on this information, third-party information may then be collected about the user.

The rating information 312 may be used to indicate the level to which the user's information has been verified as well as feedback from other users that have gone on dates with that user. The rating information may be formatted in various ways for ease of interpretation. For example, as shown, a user may be rated as “upright” or “uptight”. Alternatively, a user may be given a score or sum to indicate the feedback they've received.

The rating of the user may be based on various levels of authorization provided by the user. For example, in order to protect the privacy of a user, the user may restrict the number and types of inquiries made into their information. In addition, the authorizations could include signed forms permitting access to various records, such as vehicle records, credit reports, medical records, criminal records, etc. The user's marital status, criminal background, employment record, educational background, professional licenses, court records, driving record, credit record, and other information potentially relevant to a potential member's suitability as a date may also be included as part of the rating information.

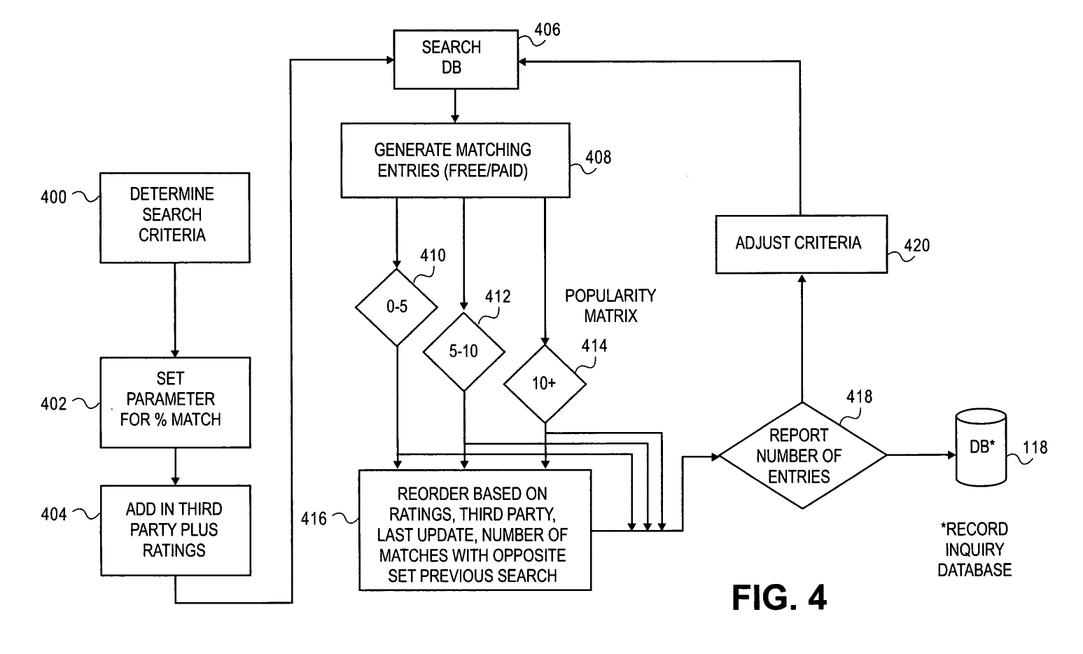

FIG. 4 shows an exemplary process flow that is consistent with embodiments of the present invention. As shown, the process begins at stage 400 by receiving search criteria for a set of candidates, for example, for a date. In stage 402, a set of parameters are then determined to select the candidates. In stage 404, the third-party information and ratings information is then added to the set of parameters.

In stage 406, the user's account database and third-party database are then searched based on the search criteria, third-party information, and ratings. In stage 408, a set of matching entries for candidates is then generated based on the query results. As shown in FIG. 4, the results may be divided into categories 410, 412, and 414. For example, in the embodiment shown in FIG. 4, the matching entries are divided into categories based on the number of criteria that they match or satisfy.

In stage 416, the matching entries of the candidates are then sorted and recompiled against the search criteria provided by the user. In stage 418, a report may then be provided to the user which lists the candidates that match the requested search criteria. The candidates may be ranked in the report based on the third-party information and ratings. In stage 420, the user may also adjust the search criteria and repeat the process. In addition, the local server 110 may store records that indicate the searches performed by the user.

FIG. 5 shows an exemplary server configured in a manner that is consistent with embodiments of the present invention. As shown, the local server 110 may include a reorder module 500, a query module 502, a record set 504, and a database driver 506. The reorder module 500 determines how to configure the third-party information 118 of a user. The query module 500 may include software and hardware for querying the third-party information 118. The record set 504 stores the third-party information 118 into a format that is usable by the local server. The database driver 506 may include the hardware and software that allow the local server to communicate with the storage devices that store the third-party information. The database driver 506 may also be configured to interface with other servers in order to obtain the third-party data indirectly.

As also shown in FIG. 5, the third-party information 118 may include opted-in data 508 and data collected by a third-party collection process 510. The opted-in data 508 may be any data that a user voluntarily authorizes to be included in the third-party database. The third-party collection process 510 may be any process by which data about a user is retrieved. For example, credit reports from various creditors of the user.

Other embodiments of the invention will be apparent to those skilled in the art from consideration of the specification and practice of the invention disclosed herein. It is intended that the specification and examples be considered as exemplary only.

What is claimed is:

1. A method of selecting candidates for a date request, comprising:
receiving a set of criteria for a date;
selecting a set of candidates that satisfy one or more of the criteria;
retrieving credentials for each of the candidates from a third-party;
ranking the candidates based on the number of criteria that they satisfy and based on the retrieved credentials; and
presenting the candidates in a format that indicates their ranking.

2. A method of selecting candidates for a date based on a third-party service, said method comprising:
receiving a set of criteria that indicate dating preferences of a user;
selecting a set of candidates from the third-party service that satisfy one or more of the set of criteria;
retrieving credentials that are confirmed by at least one credit reporting agency for each of the candidates;
underwriting information provided by the candidates based on the retrieved credentials to form a set of grades about the information provided by the candidates; and
providing a result that includes information identifying one or more of the candidates, at least a portion of the information provided by the candidates, and the underwriting grades for the respective portion of the information.

3. A system configured to confirm data provided by a user, said system comprising:
a first database configured to store information provided by the user;
a third-party database having data about the user that is confirmed by at least one credit reporting agency;
a processor configured to access the stored information, query the third-party database based on a request from at least one additional user, underwrite a set of grades about the information provided by the user based on the data that is confirmed by the at least one credit reporting agency, and provide a result that indicates the set of grades.
